(19) United States
(12) Patent Application Publication
(10) Pub. No.: US 2020/0294165 A1
(43) Pub. Date: Sep. 17, 2020

(54) BLOCKCHAIN-BASED ALLOCATION METHODS AND APPARATUSES

(71) Applicant: Alibaba Group Holding Limited, George Town (KY)

(72) Inventor: Xinying Yang, Hangzhou (CN)

(73) Assignee: Alibaba Group Holding Limited, George Town (KY)

(21) Appl. No.: 16/889,607

(22) Filed: Jun. 1, 2020

Related U.S. Application Data
(63) Continuation of application No. PCT/CN2019/075729, filed on Feb. 21, 2019.

(30) Foreign Application Priority Data
May 21, 2018 (CN) 201810491075.2

(51) Int. Cl. G06Q 50/18; G06Q 10/10; G06Q 20/12; G06F 16/23; G06F 16/27

(52) U.S. Cl. CPC G06Q 50/184; G06Q 10/10; G06F 21/10; G06F 16/2379; G06F 16/27; G06Q 20/1235

(57) ABSTRACT

A request to process a distributed transaction in a system having a plurality of blockchain systems is received. Each blockchain system maintains a separate blockchain corresponding respectively to a different entity of a plurality of entities. The distributed transaction is initiated by a member node device in a first blockchain system of the plurality of blockchain systems. The distributed transaction is associated with a usage event of a digital work, wherein the digital work is associated with multiple levels of the entities. A smart contract corresponding to a second blockchain system of the plurality of blockchain systems is invoked, including: executing distributed transaction logic for the distributed transaction defined by the smart contract for the second blockchain system; and computing amounts to be assigned to each entity of the plurality of the entities based on the multiple levels of the entities.

### CROSS-REFERENCE TO RELATED APPLICATIONS

This application is a continuation of PCT Application No. PCT/CN2019/075729, filed on Feb. 21, 2019, which claims priority to Chinese Patent Application No. 201810491075.2, filed on May 21, 2018, and each application is hereby incorporated by reference in its entirety.

### TECHNICAL FIELD

The present specification relates to the field of network communications technologies, and in particular to, blockchain-based allocation methods and apparatuses.

### BACKGROUND

Copyright refers to the rights (including property rights and personal rights) enjoyed by the authors of literary, artistic, and scientific works. The main manifestations of the work include natural science, social science, literature, music, drama, painting, sculpture, photography, picture, cinematography, etc. The authors of various works generally license the works to publishers for distribution, sale, etc. to proactively enjoy property revenue generated by their works.

Due to the lack of a unified management system for licensing or transferring copyrights of works, there is an extremely high risk of behaviors such as unauthorized transfer or licensing of the copyright of a work, and granting of an exclusive licensing right to a plurality of parties, and a licensee of a work (particularly a licensee of multiple levels of licensing involving a copyright of a work) may forge a sales transaction record to hide the actual operating revenue and consequently pay a very small amount of copyright revenue to the licensor.

### SUMMARY

In view of the previously described problem, the present specification provides a blockchain-based copyright revenue allocation method. The method includes: receiving a target transaction initiated by a member node device in a blockchain, where the target transaction corresponds to a copyright usage event of a target work; and invoking a smart contract corresponding to copyright revenue allocation of the target work, executing copyright revenue allocation logic that is declared in the smart contract and that corresponds to the copyright usage event, and allocating copyright revenue to a copyright beneficiary of the target work in the form of a transaction, where the smart contract is generated based on copyright status information that is associated with the target work and that is issued to the blockchain.

Optionally, the target work corresponds to a plurality of copyright beneficiaries; and copyright revenue allocation proportion corresponding to the plurality of copyright beneficiaries is declared in the smart contract; and allocating copyright revenue to a copyright beneficiary of the target work includes: separately allocating the copyright revenue of the target work to the plurality of copyright beneficiaries based on the copyright revenue allocation proportion corresponding to the plurality of copyright beneficiaries.

Optionally, the target work corresponds to a plurality of copyright beneficiaries; and the plurality of copyright beneficiaries include multiple levels of copyright beneficiaries, where the multiple levels of copyright beneficiaries respectively correspond to different smart contracts; and invoking a smart contract corresponding to copyright revenue allocation of the target work, executing copyright revenue allocation logic that is declared in the smart contract and that corresponds to the copyright usage event, and allocating copyright revenue to a copyright beneficiary of the target work in the form of a transaction includes: invoking a first smart contract corresponding to a first-level copyright beneficiary in the multiple levels of copyright beneficiaries, executing copyright revenue allocation logic corresponding to the copyright usage event declared in the first smart contract, and allocating copyright revenue to the first-level copyright beneficiary; submitting a copyright revenue allocation result for the first-level copyright beneficiary to a second smart contract corresponding to a second-level copyright beneficiary in the form of a transaction, initiating invocation of the second smart contract, executing copyright revenue allocation logic that is declared in the second smart contract and that corresponds to the copyright usage event, and allocating copyright revenue to the second-level copyright beneficiary; and performing the above process iteratively until the copyright revenue is allocated to each level of copyright beneficiary.

Optionally, the different smart contracts respectively correspond to different blockchains; or the different smart contracts respectively correspond to different subchains of the same blockchain.

Optionally, the smart contract is generated based on copyright status information that is associated with the target work and that is issued to the blockchain includes: obtaining the copyright status information corresponding to the target work issued to the blockchain; and invoking a smart contract creation program to create a smart contract corresponding to copyright revenue allocation of the target work based on the obtained copyright status information.

Optionally, the smart contract creation program is a smart contract that is issued in the blockchain and that is used to create a smart contract.

Optionally, the copyright status information is a template copyright contract file, the copyright status information includes a copyright contract summary, and the copyright contract summary includes a copyright licensing type, a copyright beneficiary identifier, a copyright usage event, and a copyright revenue proportion that the copyright beneficiary should obtain based on the copyright usage event.

Optionally, that the smart contract is generated based on copyright status information that is associated with the target work and that is issued to the blockchain includes: obtaining the copyright status information corresponding to the target work issued to the blockchain; and invoking a digital contract template to parse the copyright status information, where the digital contract template is a smart contract creation program that declares a copyright usage event and that corresponds to the copyright revenue allocation logic; and creating the smart contract corresponding to the copyright revenue allocation of the target work.

Optionally, the method further includes: issuing new copyright status information to the blockchain, where the new copyright status information includes copyright revenue proportion of the target work that is declared in the smart contract.

Optionally, the method further includes: deleting the smart contract; and issuing new copyright status information to the blockchain, where the copyright revenue allocation content corresponding to the smart contract is deleted from the new copyright status information.

Optionally, the smart contract and the copyright status information each include a unique identifier associated with the target work.

Optionally, the unique identifier is a digest of the target work.

Optionally, the target work is a music work.

Optionally, the blockchain is a consortium blockchain.

Correspondingly, the present specification further provides a blockchain-based copyright revenue allocation apparatus, including: a receiving module, configured to receive a target transaction initiated by a member node device in a blockchain, where the target transaction corresponds to a copyright usage event of a target work; and an execution module, configured to invoke a smart contract corresponding to copyright revenue allocation of the target work, execute copyright revenue allocation logic that is declared in the smart contract and that corresponds to the copyright usage event, and allocate copyright revenue to a copyright beneficiary of the target work in the form of a transaction, where the smart contract is generated based on copyright status information that is associated with the target work and that is issued to the blockchain.

Optionally, the target work corresponds to a plurality of copyright beneficiaries; and copyright revenue allocation proportion corresponding to the plurality of copyright beneficiaries is declared in the smart contract; and the execution module is configured to separately allocate the copyright revenue of the target work to the plurality of copyright beneficiaries based on the copyright revenue allocation proportion corresponding to the plurality of copyright beneficiaries.

Optionally, the target work corresponds to a plurality of copyright beneficiaries; and the plurality of copyright beneficiaries include multiple levels of copyright beneficiaries, where the multiple levels of copyright beneficiaries respectively correspond to different smart contracts; and the execution module is configured to: invoke a first smart contract corresponding to a first-level copyright beneficiary in the multiple levels of copyright beneficiaries, execute copyright revenue allocation logic corresponding to the copyright usage event declared in the first smart contract, and allocate copyright revenue to the first-level copyright beneficiary; submit copyright revenue allocation result for the first-level copyright beneficiary to a second smart contract corresponding to a second-level copyright beneficiary in the form of a transaction, initiate invocation of the second smart contract, execute copyright revenue allocation logic that is declared in the second smart contract and that corresponds to the copyright usage event, and allocate copyright revenue to the second-level copyright beneficiary; and perform the above process iteratively until the copyright revenue is allocated to each level of copyright beneficiary.

Optionally, the plurality of copyright beneficiaries respectively correspond to different blockchains; or the plurality of copyright beneficiaries respectively correspond to different subchains of the same blockchain.

Optionally, the smart contract is generated by a smart contract generating apparatus, and the smart contract generating apparatus includes: an acquisition unit, configured to obtain copyright status information corresponding to a target work issued to the blockchain; and an execution unit, configured to invoke a smart contract creation program to create a smart contract corresponding to copyright revenue allocation of the target work based on the obtained copyright status information.

Optionally, the smart contract is generated by a smart contract generating apparatus, and the smart contract generating apparatus includes: an acquisition unit, configured to obtain copyright status information corresponding to a target work issued to the blockchain; and an execution unit, configured to: invoke a digital contract template to parse the copyright status information, where the digital contract template is a smart contract creation program that declares a copyright usage event and that corresponds to the copyright revenue allocation logic; and create the smart contract corresponding to the copyright revenue allocation of the target work.

Optionally, the apparatus further includes: an issuing unit, configured to issue new copyright status information to the blockchain, where the new copyright status information includes copyright revenue proportion of the target work that is declared in the smart contract.

Optionally, the apparatus further includes: a deletion unit, configured to delete the smart contract; and an issuing unit, configured to issue new copyright status information to the blockchain, where the copyright revenue allocation content corresponding to the smart contract is deleted from the new copyright status information.

Correspondingly, the present specification further provides a computer device, including a storage device and a processor, where the storage device stores a computer program that can be run by the processor; and when the processor runs the computer program, steps of the previously described blockchain-based copyright revenue allocation method are performed.

Correspondingly, the present specification further provides a computer readable storage medium, where the medium stores a computer program; and when the computer program is run by a processor, steps of the previously described blockchain-based copyright revenue allocation method are performed.

According to the blockchain-based copyright revenue allocation method and apparatus, the device, and the computer-readable storage medium that are provided in the present specification, a smart contract running in the blockchain is triggered based on an actual usage event of a work to execute revenue allocation logic, so that the copyright revenue is automatically allocated to a copyright beneficiary of the work. In this way, a licensee of the work cannot forge a sales transaction record to hide the actual operating revenue and pay a very small amount of copyright expenses to the licensor. In addition, the smart contract is generated or deleted based on the copyright status information of the work stored in the blockchain, and mechanisms such as a consensus mechanism of the blockchain and tamper-resistance and counterfeiting-resistance mechanisms help avoid behaviors such as unauthorized transfer or licensing of the copyright of a work, and granting of an exclusive licensing right to a plurality of parties, thereby ensuring legal and effective execution of the smart contract. Because transparent execution of the smart contract in the blockchain provides advantages such as less human intervention and decentralization, and the consensus mechanism ensures that most of the nodes verify the execution result, thereby increasing fairness and transparency of copyright revenue allocation.

### BRIEF DESCRIPTION OF DRAWINGS

FIG. 1 is a flowchart illustrating a blockchain-based copyright revenue allocation method, according to an example implementation of the present specification;

FIG. 2(a) is a schematic diagram illustrating copyright status information, according to an example implementation of the present specification;

FIG. 2(b) is a schematic diagram illustrating new copyright status information generated based on the copyright status information in FIG. 2(a);

FIG. 2(c) is a schematic diagram illustrating a smart contract generated based on the copyright status information in FIG. 2(b);

FIG. 2(d) is a schematic diagram illustrating new copyright status information generated based on the copyright status information in FIG. 2(a);

FIG. 3(a) is a schematic diagram illustrating copyright status information, according to another example implementation of the present specification;

FIG. 3(b) is a schematic diagram illustrating a smart contract generated based on the copyright status information in FIG. 3(a);

FIG. 3(c) is a schematic diagram illustrating new copyright status information generated based on the copyright status information in FIG. 3(a);

FIG. 3(d) is a schematic diagram illustrating another smart contract generated based on the copyright status information in FIG. 3(a);

FIG. 4 is a schematic diagram illustrating a blockchain-based copyright revenue allocation apparatus, according to an example implementation of the present specification; and

FIG. 5 is a diagram illustrating a hardware structure for executing a blockchain-based copyright revenue allocation method or apparatus implementation according to the present specification.

### DESCRIPTION OF IMPLEMENTATIONS

With the implementation of the national intellectual property protection strategy, more and more attention has been paid to copyright protection of works. The main manifestations of the work include natural science, social science, literature, music, drama, painting, sculpture, photography, picture, cinematography, etc. With the development of the Internet, more and more works in the form of literature or music have been used in violation of regulations, or the copyright owner or other beneficiaries have not been paid the copyright revenue as agreed. The present specification is intended to provide a blockchain-based copyright revenue allocation method and apparatus to avoid the previously described unlawful use of copyrights of works and false and dishonest behaviors.

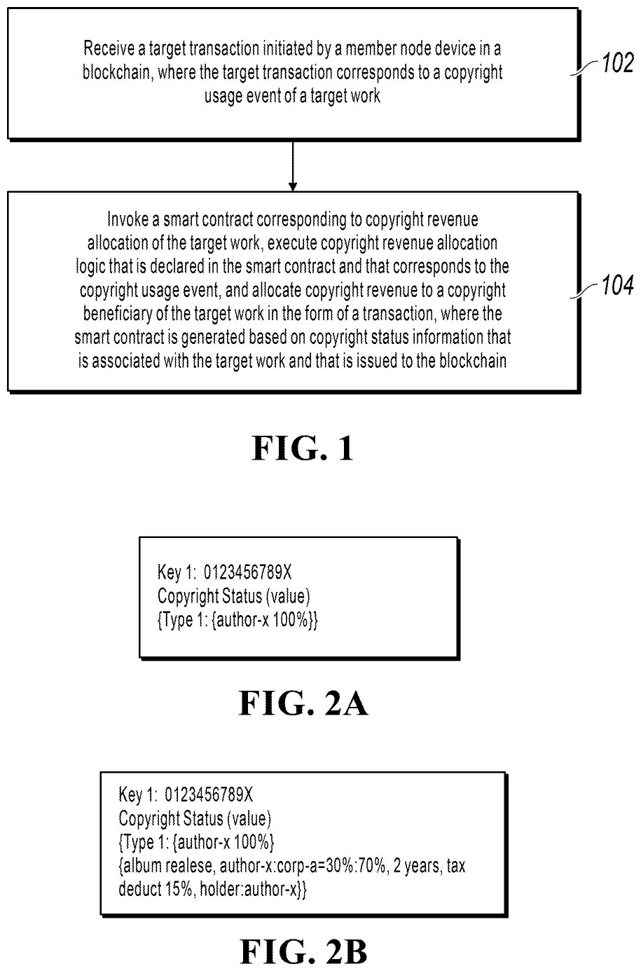

FIG. 1 is a flowchart illustrating a blockchain-based copyright revenue allocation method, according to an example implementation of the present specification. The method includes:

Step 102: Receive a target transaction initiated by a member node device in a blockchain, where the target transaction corresponds to a copyright usage event of a target work; and

Step 104: Invoke a smart contract corresponding to copyright revenue allocation of the target work, execute copyright revenue allocation logic that is declared in the smart contract and that corresponds to the copyright usage event, and allocate copyright revenue to a copyright beneficiary of the target work in the form of a transaction, where the smart contract is generated based on copyright status information that is associated with the target work and that is issued to the blockchain.

The copyright owner of a work generally licenses the copyright of the work to the licensee to obtain more copyright use revenue, and obtains more revenue through the operation of the work by the licensee. For example, a copyright holder of a music work (including a case in which one or more parties hold the music work) can sign and grant a license for copying and distributing a music work to a music album releasing company and negotiate the allocation proportion of the revenue generated by music distribution with the music album releasing company. The “copyright usage event” described in this implementation is the use of a copyright work as agreed between the copyright holder and the licensee, such as purchasing of a music album, online paid downloading of a music work, online playing of a music work, and use of a derivative of the copyright work, for example, downloading of a ringtone. The “copyright beneficiary” described in this implementation includes each of the previously described copyright holders, copyright licensees, etc., which are entitled to gain revenue based on the use of the copyright of the work.

In the implementations of the present specification, to avoid behaviors such as unauthorized transfer or licensing of the copyright of a work, and granting of an exclusive licensing right to a plurality of parties, the copyright status information of the work can be recorded in a blockchain, and the copyright status information can include a contract information summary related to each copyright transfer or license legal contract, and the contract information summary can include contents such as each beneficiary agreed by the specific legal contract and a revenue allocation proportion generated based on various copyright usage events. Further, to ensure that the copyright status information of the work uniquely points to the work, the copyright status information can further include a unique identifier corresponding to the work. The unique identifier can be generated by using a variety of methods, for example, an identifier is generated based on labels such as a name of the work, an author, a creation completion time, and a creation location by using a predetermined identifier generation algorithm. Because a combination of the labels can uniquely point to a work, a unique identifier can be generated. In addition, the unique identifier can be associated with the content of the work, a digest can be generated for the work or the encoded work by using a digest algorithm (such as a hash algorithm), and the digest can be used as the unique identifier.

The blockchain network described in one or more implementations of the present specification can specifically refer to a P2P network system that is formed by nodes based on a consensus mechanism and that has a distributed data storage structure. In the blockchain network, data is distributed in temporally consecutive “blocks”, each block includes a data summary of a previous block, and data of all or some of the nodes is backed up, depending on a specific consensus mechanism (for example, POW, POS, DPOS, or PBFT). A person skilled in the art knows that because the blockchain network system runs under the corresponding consensus mechanism, it is difficult for any node to tamper with the data already recorded in the blockchain database. For example, for the blockchain based on the POW consensus mechanism, at least 51% of the computing capability of the entire network is required to launch an attack to tamper with the existing data. Therefore, the blockchain system has incomparable data security and tamper-resistance features over other centralized database systems. After the copyright status information described in this implementation is recorded in the blockchain, copyright evidence storage can be implemented for the work, the copyright status information can be obtained by the node device in the blockchain, and it can be determined whether there is any legal contract basis for the use of the work or whether the use of the work is unauthorized or illegal.

In the implementations described in the present specification, a smart contract corresponding to the copyright revenue allocation of the work is generated based on the content of the copyright status information, and the smart contract is deployed in the blockchain. The smart contract declares copyright revenue allocation logic corresponding to various possible copyright usage events, that is, a revenue proportion should be obtained by each copyright beneficiary based on the revenue gained from each copyright usage event. If any one of the previously described copyright usage events occur, for example, a user pays for downloading a music work, a target transaction corresponding to the copyright usage event in the blockchain can be initiated to the smart contract by a member node device in the blockchain, where the target transaction can include the content or type of the current copyright usage event, the fee, and the address and API of the smart contract, to invoke the smart contract to execute the copyright revenue allocation logic corresponding to the copyright usage event such as paying for downloading the music at the execution of the smart contract, so as to allocate the revenue corresponding to each copyright beneficiary to each copyright beneficiary in proportion in the form of the transaction, that is, the form of the smart contract transferring to the accounts of each copyright beneficiary.

The “member node device in a blockchain” can be a computer device that performs the behavior of paid downloading of a music work that is initiated by a client, can be a server in which an online platform providing a music work downloading service, or can be another device communicating with the previous client or server. The device needs to comply with the node service protocol running blockchain, and needs to be added to the blockchain to become a blockchain node.

In the previously described implementations provided in the present specification, a smart contract running in the blockchain is triggered based on an actual usage event of a work to execute revenue allocation logic, so that the copyright revenue is automatically allocated to a copyright beneficiary of the work. In this way, a licensee of the work cannot forge a sales transaction record to hide the actual operating revenue and cannot conduct fraud market behavior, for example, pay a very small amount of copyright expenses to the licensor or copyright holder. In addition, the smart contract is generated or deleted based on the copyright status information of the work stored in the blockchain, and mechanisms such as a consensus mechanism of the blockchain and tamper-resistance and counterfeiting-resistance mechanisms help avoid behaviors such as unauthorized transfer or licensing of the copyright of a work, and granting of an exclusive licensing right to a plurality of parties, thereby ensuring the legal and effective execution of the smart contract.

In an implementation illustrated in the present specification, a consortium blockchain architecture can generally be used to build the blockchain to reduce the verification time of the data in the blockchain, increase a transaction throughput, and meet security and performance needs. For example, in a consortium blockchain based on music copyright use, a credible authority, such as a large music album releasing company or an online music platform with high user traffic, can be selected as a member node of the consortium blockchain to participate in accounting of a block. The consortium blockchain can determine the degree of openness to the public based on an application scenario, and grant access rights to an authorized organization. For example, in this implementation, a large music album releasing company or relicensed releasing company, and an online music platform with high user traffic can participate in accounting for member nodes, and a user corresponding to each copyright usage event can be a general node with access rights to the consortium blockchain.

It is worthwhile to note that when a member node device in a consortium blockchain performs consensus processing on a smart contract issued to the blockchain, a consensus algorithm used and a specific consensus process are omitted in the present specification for simplicity, and a person skilled in the art can implement the technical solution described in the specification by referring to the descriptions in the related art.

The transaction described in the present specification refers to a group of data that is created by a user through a blockchain client and that needs to be finally sent to a distributed database in the blockchain. A transaction in the blockchain has a narrow sense and a broad sense. A transaction in a narrow sense refers to a value transfer initiated to a user to the blockchain. For example, in a conventional bitcoin blockchain network, a transaction can be a transfer initiated by a user in the blockchain. In a broad sense, a transaction refers to a group of data that is issued by a user to the blockchain and that includes a service intention. For example, an operator can build a consortium blockchain based on an actual service need, and deploy some other online services unrelated to value transfer based on the consortium blockchain, such as house renting service, vehicle dispatching service, insurance claim settlement service, credit service, and medical service. In such a consortium blockchain, a transaction can be a service message or service request that is issued by a user in the consortium blockchain and that includes a service intention. In the implementations described in the present specification, the specific type of “target transaction” is not limited, provided that the events involving the actual copyright use of the work are within the protection scope of the present specification.

In the implementations provided in the present specification, there can be a plurality of specific ways and processes for developing a smart contract corresponding to the allocation of copyright revenue based on the copyright status information. The following describes specific processes of development, deployment, and copyright allocation of the smart contract corresponding to the allocation of the copyright revenue in several service scenarios.

(1) One-Level Copyright Licensing Service Scenario

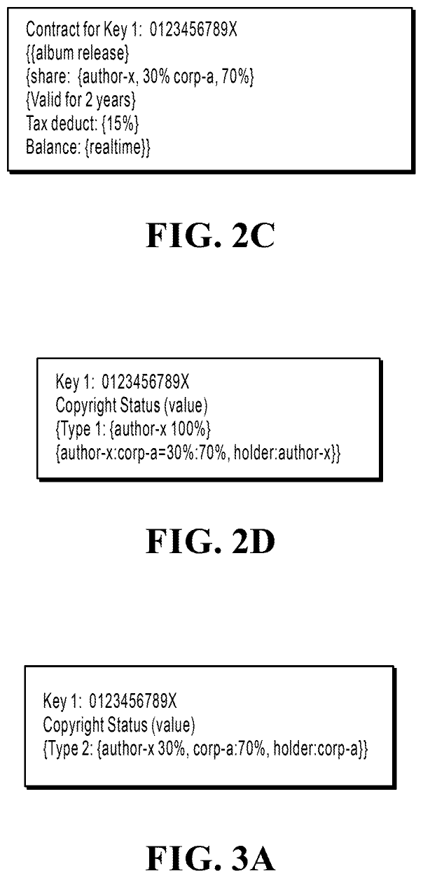

100% of the copyright of a music work is owned by the music author X, and the copyright status information of the music work can be uploaded in the consortium blockchain by the music author X, an authority in charge of copyright evidence storage, or the like in the consortium blockchain. As shown in FIG. 2(a), the value of Key 1 is 0123456789X, which is a hash data summary generated based on the content of the music work, and 100% of the copyright of the music work is owned by the author X.

The author X cooperates with the music album releasing company CORP-A to release a music album, and both parties sign a legal contract: the author X and CORP-A share the revenue gained from the event of releasing a music album based on a proportion of 30%: 70%, the contract is valid for two years, and CORP-A does not have the relicensing right. Then, according to the contract or the provisions in the consortium blockchain, the parties involved in the legal contract or the authority responsible for storing copyright evidence or other authorized member nodes in the consortium blockchain can update the copyright status information in the consortium blockchain as shown in FIG. 2(b). The contract summary information can be added to the copyright status information, and the contract summary information can generally include content such as a copyright licensing type (a holder indicating a party having a copyright relicensing right), a copyright beneficiary identifier, a copyright usage event, and a copyright revenue proportion that the copyright beneficiary should obtain based on the copyright usage event.

After obtaining the copyright status information shown in FIG. 2(b) from the consortium blockchain, the developer of the smart contract can invoke a smart contract creation program. The smart contract creation program can parse the Key 1 information and the contract summary information in the copyright status information (for example, parsing by using a parser) to generate the smart contract program including the copyright revenue allocation logic corresponding to the copyright usage event, as shown in FIG. 2(c). The smart contract can include an identifier “Key 1” for association with the music work, and can also include revenue allocation logic: For example, after 15% of the revenue is deducted as the tax, the remaining revenue is allocated to the account address of the author X and the releasing company CORP-A. The allocation can be performed in real time, or can be performed on a monthly or quarterly basis as stipulated in the legal contract. In addition, the smart contract provided in this implementation further includes validity period information of the smart contract. The smart contract can be deleted when the validity period expires. The executor of the deletion operation can be a smart contract developer or deployer or another smart contract in the blockchain. Alternatively, the deletion operation can be performed by the smart contract itself based on a timer run by the smart contract. Details are omitted here for simplicity. After the smart contract is deleted, new copyright status information should be issued to the blockchain, where the copyright revenue allocation content corresponding to the smart contract is deleted from the new copyright status information.

As can be seen from the above, to facilitate the smart contract creation program in parsing the content of the copyright status information, the copyright status information is also a template copyright contract file, the copyright status information includes a unique identifier associated with the target work and a copyright contract summary, where the copyright contract summary includes a copyright contract licensing type, a copyright beneficiary identifier, a copyright usage event, and a copyright revenue proportion that the copyright beneficiary should obtain based on the copyright usage event. In addition, other information such as a tax deduction amount, a contract validity period, and a settlement method can be included to generate revenue allocation logic of the smart contract. In this implementation, the copyright contract licensing type is indicated by the “holder” indicator, and the “holder” indicator indicates the owner of the copyright relicensing right. A person skilled in the art can select another indicator to indicate the copyright contract licensing type, which is not limited in the present specification. In addition, in this implementation, the smart contract can be developed based on one piece of copyright licensing contract summary information in the copyright status information, or can be developed based on a plurality of pieces of copyright licensing contract summary information in the copyright status information. This is not limited in the present specification.

Optionally, the program for creating the copyright revenue allocation smart contract can be a smart contract running in a blockchain. An instruction for sending all or part of the content including the copyright status information can be sent to the address of the smart contract to invoke the smart contract to execute the program for creating the copyright revenue allocation smart contract based on all or part of the content of the copyright status information, so that the copyright revenue allocation smart contract is more conveniently and fairly created.

It is worthwhile to note that the smart contract creation program described in the present specification can alternatively be a digital contract template directly generated based on a copyright license law contract, and the digital contract template can be used to read or parse the copyright status content to create a smart contract related to the content of the digital contract template. In the above example, the author X cooperates with the music album releasing company CORP-A to release a music album, and both parties sign a legal contract: the author X and CORP-A share the revenue gained from the event of releasing a music album based on a proportion of 30%: 70%, the contract is valid for two years, and CORP-A does not have the relicensing right. After the legal contract is signed, a digital contract template can be first generated based on the content of the contract. Similarly, the copyright contract summary includes a copyright licensing type, a copyright beneficiary identifier, a copyright usage event, and a copyright revenue proportion that the copyright beneficiary should obtain based on the copyright usage event. In addition, other information such as a tax deduction amount, a contract validity period, and a settlement method can be included to generate revenue allocation logic of the smart contract. Then, the copyright status information that is obtained from the blockchain and that is shown in FIG. 2(a) is parsed by using the digital contract template including the agreed content of the legal contract (for example, parsing by using a parser), and Key 1 and copyright holding status Type 1 are read, so as to finally generate a smart contract program as shown in FIG. 2(c). After the smart contract is created, the revenue allocation proportion of each beneficiary in the revenue allocation logic of the smart contract can be added to the existing copyright status information, and the updated copyright status information can be uploaded to the blockchain, as shown in FIG. 2(d). Because a copyright revenue allocation proportion corresponding to a specific copyright usage event has been generated based on the content of the digital contract template, the copyright status information can be updated without adding the related copyright usage event, and only the revenue proportion of each beneficiary is added, thereby further saving the space occupied by the block.

Therefore, the present specification does not limit a specific method and step for generating a smart contract based on copyright status information related to a work issued to the blockchain. In a specific service scenario, a person skilled in the art generates a smart contract related to revenue allocation by using the copyright status information in the blockchain based actual implementation needs. In addition, to store evidence for the copyright usage of the work and avoid behaviors such as unauthorized licensing of the copyright of a work and granting of an exclusive licensing right to a plurality of parties, the copyright status information in the blockchain is updated in time to achieve the purpose of evidence storage.

For a developed smart contract, a smart contract deployer can publish the smart contract to the consortium blockchain through any node device in the consortium blockchain, and the smart contract deployer can be a party related to the legal contract, a service provider designated in the consortium blockchain to develop and deploy the copyright revenue allocation smart contract, etc. In addition, after the member node devices designated in the smart contract in the consortium blockchain (for example, a plurality of designated node devices that have the accounting right in the consortium blockchain) complete the consensus processing on the smart contract, the smart contract is recorded in a distributed database (that is, a distributed ledger) in the consortium blockchain. Subsequently, the user can submit a copyright usage event transaction (transfer) to the smart contract recorded in the consortium blockchain through a client accessing any node device of the consortium blockchain. For example, a user's operation of purchasing a music album CD online and paying for the CD is sent to the address of the smart contract in the form of a transaction instruction to initiate invocation of the smart contract, trigger execution of related revenue allocation service logic in the consortium blockchain, and allocate copyright revenue to copyright beneficiaries declared in the smart contract. The allocation method can be initiating a transfer transaction to an account address of each beneficiary in the consortium blockchain.

(2) Multiple levels of copyright licensing service scenario

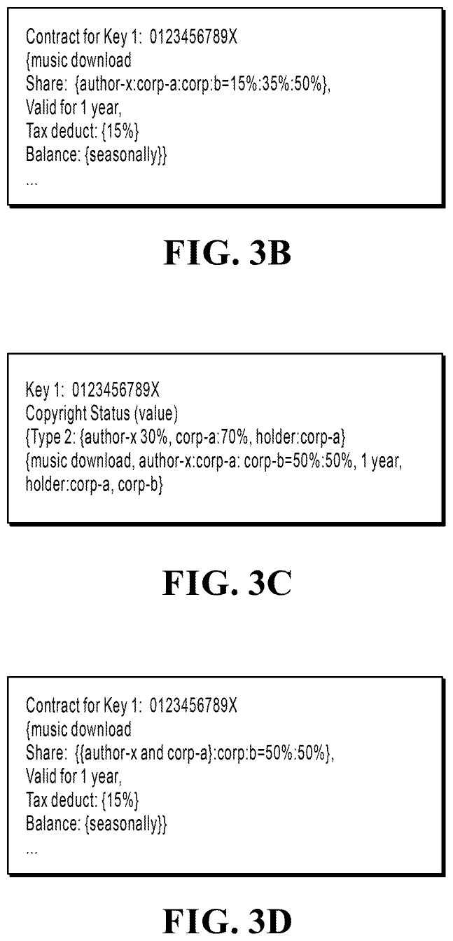

In this scenario, if the author X cooperates with the releasing company CORP-A with respect to the operation of a music work, and both parties sign a legal contract: the author X and CORP-A share the revenue gained from the operation of the music work that is executed by CORP-A based on a proportion of 30%: 70%, and the contract is valid for two years. The contract further stipulates that CORP-A can act as a licensor to sign a copyright licensing contract with other companies for the operation of the music work and stipulate related copyright revenue allocation. Correspondingly, the copyright status information shown in FIG. 3(a) can include a contract summary corresponding to the legal contract. The parameter “type” can be used to identify the copyright licensing type. For example, the copyright licensing type in which only one party can obtain the copyright revenue as a licensor, as shown in the above example, is type 1; and the copyright licensing type in which a plurality of parties can obtain the copyright revenue and the licensor is one of the parties, as shown in this example, is type 2. The parameter “holder” can be used to identify the beneficiary who has the relicensing right, so as to store a legal certificate for the licensing right of the party, thereby preventing relicensing by a party who does not possess the relicensing right.

Further, CORP-A and CORP-B cooperate with each other with respect to the use of the music work, and both parties sign a legal contract. The contract stipulates the following: CORP-A authorizes CORP-B to use the music file on a music website platform of CORP-B so that users download the music work from the music website platform; CORP-A and CORP-B share the revenue based on a proportion of 1:1; the tax rate of the revenue is 15%, the contract is valid for one year; and CORP-B has the right to relicense the music work.

Next, the following describes generating of a smart contract by using a method for generating a digital contract template according to a copyright license law contract and based on copyright status information obtained from the consortium blockchain as an example. Specifically, CORP-A, CORP-B, or a party responsible for generating the contract template can first generate a digital contract template based on the contract signed by CORP-A and CORP-B, where the template includes a copyright usage event (downloading a music work), a copyright revenue allocation proportion (CORP-A and CORP-B share the revenue based on a proportion of 1:1), a contract validity period (one year), and relicensing party (CORP-A and CORP-B). Then, the copyright status information shown in FIG. 3(a) is obtained from the consortium blockchain, and the copyright status information is parsed based on the generated digital contract template (for example, parsing by using a parser), and the content of the Key 1 and the content of the copyright holding status Type 2 are read. Then, the revenue allocation proportion in the copyright status information and the revenue allocation proportion in the contract template are combined, and the final copyright revenue allocation proportion is parsed into “author X:CORP-A:CORP-B=15%:35%:50%”, and finally a smart contract program as shown in FIG. 3(b) is generated. In addition, the contents such as the specific copyright allocation proportion and the licensor type generated by the legal contract should be stored in the copyright status information for the purpose of evidence storage for the legal contract, as shown in FIG. 3(c).

After the smart contract is deployed and uploaded, the user can submit a copyright usage event transaction (transfer) to the smart contract recorded in the consortium blockchain through a client accessing any node device of the consortium blockchain. For example, a user's operation of downloading a music work and paying for the music work is sent to the address of the smart contract in the form of a transaction instruction to initiate invocation of the smart contract, trigger execution of related revenue allocation service logic in the consortium blockchain, and allocate copyright revenue to copyright beneficiaries declared in the smart contract. The allocation method can be initiating a transfer transaction to the account of each related beneficiary in the consortium blockchain: the author X, CORP-A, and CORP-B.

Optionally, in the generation process of the smart contract, the generated digital contract template is used to parse (for example, parsing by using a parser) the copyright status information, the content of Key 1 and the content of copyright holding status Type 2 are read, the revenue allocation proportion in the copyright status information and the revenue allocation proportion in the contract template are combined, and the smart contract shown in FIG. 3(d) is generated. In the copyright revenue allocation logic of the smart contract, the plurality of copyright beneficiaries include two-level copyright beneficiaries, and the legal contract is a contract between CORP-B and a combination of CORP-A and the author X. CORP-B can be viewed as a level-1 beneficiary, and a combination of CORP-A and the author X is also a level-1 beneficiary. In this example, the author X and CORP-A have already corresponded to a copyright revenue allocation smart contract because of the previously established license operation cooperation relationship, the copyright revenue allocation smart contract can be referred to as a second smart contract, and CORP-A and the author X are respectively level-2 beneficiaries; and the cooperation relationship between CORP-B and CORP-A corresponds to the first smart contract shown in FIG. 3(d).

The user can submit a copyright usage event transaction (transfer) to the first smart contract recorded in the consortium blockchain by accessing a client of any node device in the consortium blockchain. For example, a user's operation of downloading a music work and paying for the music work is sent to the address of the smart contract in the form of a transaction instruction to initiate invocation of the smart contract, trigger execution of related revenue allocation service logic in the consortium blockchain, and allocate copyright revenue to the level-1 copyright beneficiary CORP-B and a combination of CORP-A and the author X declared in the smart contract.

Next, the copyright revenue allocation result for the level-1 beneficiary of the combination of the copyright beneficiary CORP-A and the author X is submitted to the second smart contract corresponding to the level-2 copyright beneficiaries CORP-A and the author X in the form of a transaction to initiate invocation of the second smart contract, execute the copyright revenue allocation logic that is declared in the second smart contract and that corresponds to the copyright usage event, and allocate the copyright revenue to the level-2 copyright beneficiaries, that is, the author and the CORP-A, for example, based on a proportion of 30%: 70%.

If more levels of copyright beneficiaries are involved in a specific copyright license service, a person skilled in the art should know that the above process is performed iteratively starting from a first smart contract related to a copyright usage event until the allocation of the copyright revenue is allocated to copyright beneficiaries at each level. Details are omitted here for simplicity.

In another illustrated implementation, the different smart contracts respectively correspond to different blockchains; or the different smart contracts respectively correspond to different subchains of the same blockchain. In brief, the first smart contract corresponds to the first blockchain, the second smart contract corresponds to the second blockchain, and so on. By providing a cross-chain interaction device between the first blockchain and the second blockchain, the first blockchain and the second blockchain can implement message interaction based on the cross-chain interaction device, thereby enabling interaction between different blockchains or between different subchains of the same blockchain. For example, the second blockchain subscribes to a message on the first blockchain. After the first smart contract in the first blockchain is invoked, the first smart contract sends a transaction message to the cross-chain interaction device for transferring to the second smart contract. After the second blockchain obtains the transaction message, the second smart contract is invoked to execute the revenue allocation logic declared in the second smart contract to allocate the revenue to related beneficiaries. The first blockchain and the second blockchain can be different blockchains or different subchains of the same blockchain.

In the above description, a process of generating, deploying, and performing copyright revenue allocation by using a copyright allocation smart contract is described based on two different service scenarios. In the previously described implementation, a method for parsing copyright status information by using a smart contract creation program or a template generated by a legal contract to generate a corresponding smart contract is provided. It is worthwhile to note that the present specification does not limit the specific generation method of the smart contract, and a person skilled in the art can develop more specific generation steps of the smart contract based on actual copyright status content needs and a specific data parsing technology. However, to implement evidence storage for the usage status of a work and to prevent behaviors such as unauthorized transfer or licensing of the copyright of the work and granting of an exclusive licensing right to a plurality of parties, the licensor of the copyright licensing contract or the authority with a notarization effect in the consortium blockchain should upload the key legal information such as each beneficiary, the revenue allocation proportion, and the licensing type (which is used to determine whether a licensee has the relicensing right) involved in the copyright licensing contract to the blockchain for evidence storage, so that the content of the copyright status information stored in the blockchain corresponds to the copyright allocation smart contract, any copyright usage event stipulated in the contract is associated with the smart contract, and the smart contract can be invoked by any copyright usage event to initiate the behavior of paying the revenue to the copyright beneficiary, thereby preventing the licensee from hiding its actual operating revenue and consequently pay a very small amount of copyright revenue to the licensor, and achieving the beneficial effect of honesty and trustworthiness.

Corresponding to the previously described process implementation, an implementation of the present specification further provides a blockchain-based copyright revenue allocation apparatus. The apparatus can be implemented by using software, hardware, or a combination thereof. The software-based implementation is used as an example. As a logical apparatus, the apparatus is formed by reading, by the central processing unit (CPU) in a device where the apparatus is located, corresponding computer program instructions to a memory for running. At the hardware level, in addition to the CPU, the memory, and the storage device shown in FIG. 5, the device in which the blockchain-based copyright revenue allocation apparatus generally includes other hardware such as a chip for transmitting and receiving wireless signals, and/or other hardware such as a board for implementing a network communication function.

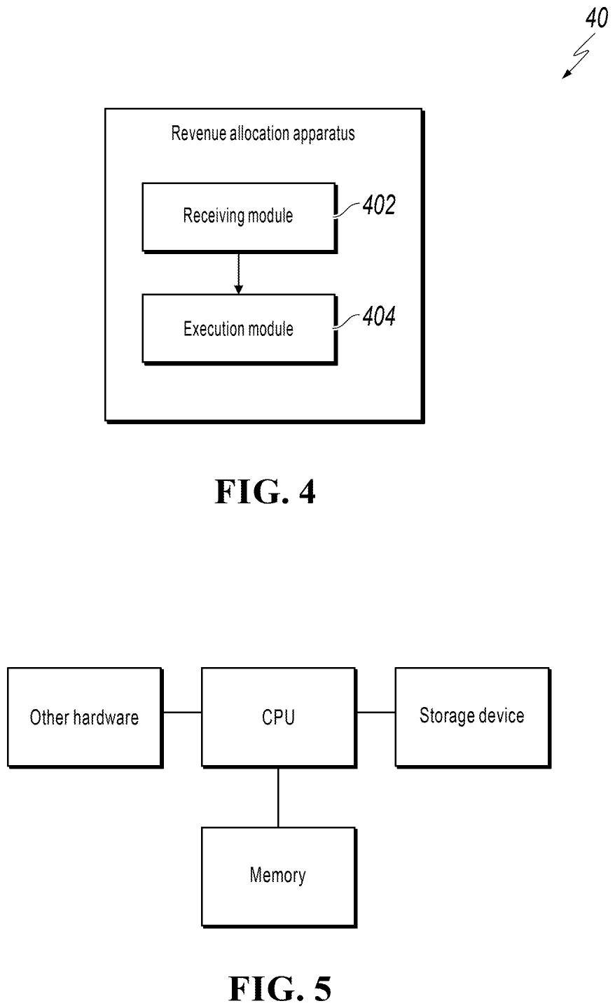

FIG. 4 is a schematic diagram illustrating a blockchain-based copyright revenue allocation apparatus 40, according to an example implementation of the present specification. The apparatus 40 includes: a receiving module 402, configured to receive a target transaction initiated by a member node device in a blockchain, where the target transaction corresponds to a copyright usage event of a target work; and an execution module 404, configured to invoke a smart contract corresponding to copyright revenue allocation of the target work, execute copyright revenue allocation logic that is declared in the smart contract and that corresponds to the copyright usage event, and allocate copyright revenue to a copyright beneficiary of the target work in the form of a transaction, where the smart contract is generated based on copyright status information that is associated with the target work and that is issued to the blockchain.

Optionally, the target work corresponds to a plurality of copyright beneficiaries; and copyright revenue allocation proportion corresponding to the plurality of copyright beneficiaries is declared in the smart contract; and the execution module is configured to separately allocate the copyright revenue of the target work to the plurality of copyright beneficiaries based on the copyright revenue allocation proportion corresponding to the plurality of copyright beneficiaries.

Optionally, the target work corresponds to a plurality of copyright beneficiaries; and the plurality of copyright beneficiaries include multiple levels of copyright beneficiaries, where the multiple levels of copyright beneficiaries respectively correspond to different smart contracts; and the execution module is configured to: invoke a first smart contract corresponding to a first-level copyright beneficiary in the multiple levels of copyright beneficiaries, execute copyright revenue allocation logic corresponding to the copyright usage event declared in the first smart contract, and allocate copyright revenue to the first-level copyright beneficiary; submit copyright revenue allocation result for the first-level copyright beneficiary to a second smart contract corresponding to a second-level copyright beneficiary in the form of a transaction, initiate invocation of the second smart contract, execute copyright revenue allocation logic that is declared in the second smart contract and that corresponds to the copyright usage event, and allocate copyright revenue to the second-level copyright beneficiary; and perform the above process iteratively until the copyright revenue is allocated to each level of copyright beneficiary.

Optionally, the plurality of copyright beneficiaries respectively correspond to different blockchains; or the plurality of copyright beneficiaries respectively correspond to different subchains of the same blockchain.

Optionally, the smart contract is generated by a smart contract generating apparatus, and the smart contract generating apparatus includes: an acquisition unit, configured to obtain copyright status information corresponding to a target work issued to the blockchain; and an execution unit, configured to invoke a smart contract creation program to create a smart contract corresponding to copyright revenue allocation of the target work based on the obtained copyright status information.

Optionally, the smart contract is generated by a smart contract generating apparatus, and the smart contract generating apparatus includes: an acquisition unit, configured to obtain copyright status information corresponding to a target work issued to the blockchain; and an execution unit, configured to: invoke a digital contract template to parse the copyright status information, where the digital contract template is a smart contract creation program that declares a copyright usage event and that corresponds to the copyright revenue allocation logic; and create the smart contract corresponding to the copyright revenue allocation of the target work.

Optionally, the apparatus further includes: an issuing unit, configured to issue new copyright status information to the blockchain, where the new copyright status information includes copyright revenue proportion of the target work that is declared in the smart contract.

Optionally, the apparatus further includes: a deletion unit, configured to delete the smart contract; and an issuing unit, configured to issue new copyright status information to the blockchain, where the copyright revenue allocation content corresponding to the smart contract is deleted from the new copyright status information.

For a detailed implementation process of the functions of the units or modules in the previously described apparatus, references can be made to the implementation process of the corresponding steps in the method implementation. Details are omitted here for simplicity.

The previously described device implementations are merely examples, where the units described as separate parts can or does not have to be physically separate, and components displayed as units can or does not have to be physical units, can be located in one place, or can be distributed on a plurality of network units. Based on actual needs, some or all of these modules can be selected to implement the purpose of the present specification. A person of ordinary skill in the art can understand and implement the blockchain-based copyright revenue allocation apparatus without creative efforts.

The devices or units illustrated in the previously described implementations can be implemented by computer chips, entities, or products having a certain function. A typical implementation device is a computer in the form of a personal computer, a laptop computer, a cellular phone, a camera phone, a smart phone, a personal digital assistant, a media player, a navigation device, an e-mail transceiver, a game console, a tablet computer, a wearable device, or any combination of at least two of these devices.

Corresponding to the previously described method implementations, an implementation of the present specification further provides a computer device, where the computer device includes a storage device and a processor. The storage device stores a computer program that can be run by the processor. When the processor runs the stored computer program, steps of the blockchain-based copyright revenue allocation method performed in the implementation of the present specification are performed. For a detailed description of the steps of the blockchain-based copyright revenue allocation method, references can be made to the above descriptions. Details are omitted here for simplicity.

Corresponding to the previously described method implementations, an implementation of the present specification further provides a computer device, where the computer device includes a storage device and a processor. The storage device stores a computer program that can be run by the processor. When the processor runs the stored computer program, steps of the blockchain-based copyright revenue allocation method performed in the implementation of the present specification are performed. For a detailed description of the steps of the blockchain-based copyright revenue allocation method, references can be made to the above descriptions. Details are omitted here for simplicity.

Corresponding to the previously described method implementations, an implementation of the present specification further provides a computer readable storage medium, where the medium stores a computer program; and when the computer program is run by a processor, steps of the blockchain-based copyright revenue allocation method in the implementation of the present specification are performed. For a detailed description of the steps of the blockchain-based copyright revenue allocation method, references can be made to the above descriptions. Details are omitted here for simplicity.

Corresponding to the previously described method implementations, an implementation of the present specification further provides a computer readable storage medium, where the medium stores a computer program; and when the computer program is run by a processor, steps of the blockchain-based copyright revenue allocation method in the implementation of the present specification are performed. For a detailed description of the steps of the blockchain-based copyright revenue allocation method, references can be made to the above descriptions. Details are omitted here for simplicity.

The above descriptions are merely preferred implementations of one or more implementations of the present specification, and are not intended to limit the present specification. Any modification, equivalent replacement, improvement, etc., made without departing from the spirit and principles of the present specification shall fall within the protection scope of the present specification.

In a typical configuration, a computing device includes one or more processors (CPUs), an input/output interface, a network interface, and a memory.

The memory can include a non-persistent memory, a random access memory (RAM), a non-volatile memory, and/or another form that are in a computer readable medium, for example, a read-only memory (ROM) or a flash memory (flash RAM). The memory is an example of the computer readable medium.

The computer readable medium includes persistent, non-persistent, movable, and unmovable media that can store information by using any method or technology. The information can be a computer readable instruction, a data structure, a program module, or other data.

Examples of the computer storage medium include but are not limited to a phase change random access memory (PRAM), a static random access memory (SRAM), a dynamic random access memory (DRAM), another type of RAM, a ROM, an electrically erasable programmable read-only memory (EEPROM), a flash memory or another memory technology, a compact disc read-only memory (CD-ROM), a digital versatile disc (DVD) or another optical storage, a cassette magnetic tape, a magnetic tape/magnetic disk storage, another magnetic storage device, or any other non-transmission medium. The computer storage medium can be used to store information accessible by a computing device. Based on the definition in the present specification, the computer readable medium does not include transitory media such as a modulated data signal and carrier.

It is worthwhile to note that terms “include”, “comprise” or any other variant is intended to cover non-exclusive inclusion, so that processes, methods, products or devices that include a series of elements include not only those elements but also other elements that are not explicitly listed, or elements inherent in such processes, methods, products or devices. An element described by “includes a . . . ” further includes, without more constraints, another identical element in the process, method, product, or device that includes the element.

A person skilled in the art should understand that the implementations of the present specification can be provided as methods, systems, or computer program products. Therefore, the implementations of the present specification can take a form of hardware implementations, software implementations, or both. Further, the implementations of the present specification can take a form of computer program products implemented on one or more computer-usable storage media (including but not limited to a disk storage device, CD-ROM, and an optical storage device) containing computer-usable program code.

What is claimed is:

1. A computer-implemented method, comprising:
receiving a request to process a distributed transaction in a system having a plurality of blockchain systems, each blockchain system maintaining a separate blockchain corresponding respectively to a different entity of a plurality of entities, wherein the distributed transaction is initiated by a member node device in a first blockchain system of the plurality of blockchain systems, and wherein the distributed transaction is associated with a usage event of a digital work, wherein the digital work is associated with multiple levels of the entities; and
invoking a smart contract corresponding to a second blockchain system of the plurality of blockchain systems, comprising:
executing distributed transaction logic for the distributed transaction defined by the smart contract for the second blockchain system; and
computing amounts to be assigned to each entity of the plurality of the entities based on the multiple levels of the entities.

2. The computer-implemented method of claim 1, wherein a distributed transaction proportion corresponding to each entity is declared in the smart contract; and computing the amounts to be assigned to each entity of the plurality of the entities based on the multiple levels of the entities comprises:
computing amounts to be assigned to each entity of the plurality of the entities based on the distributed transaction proportion corresponding to each entity.

3. The computer-implemented method of claim 1, wherein invoking the smart contract corresponding to the second blockchain system of the plurality of blockchain systems comprises:
invoking a first smart contract corresponding to a first-level entity in the multiple levels of the entities, comprising:
executing distributed transaction logic corresponding to the usage event declared in the first smart contract; and
computing amounts to be assigned to the first-level entity;
submitting a distributed transaction result for the first-level entity to a second smart contract corresponding to a second-level entity;
invoking the second smart contract, comprising:
executing distributed transaction logic that is declared in the second smart contract and that corresponds to the usage event; and
computing amounts to be assigned to the second-level entity; and
performing the above process iteratively until the amounts to be assigned to each level of the multiple levels of the entities are computed.

4. The computer-implemented method of claim 1, wherein the smart contract is generated based on a distributed transaction status information that is associated with the digital work and that is issued to the first blockchain system, comprising:
obtaining the distributed transaction status information that is associated with the digital work and that is issued to the first blockchain system; and
invoking a smart contract creation program to create the smart contract corresponding to the distributed transaction of the digital work based on the distributed transaction status information.

5. The computer-implemented method of claim 4, wherein generating the smart contract based on the distributed transaction status information that is associated with the digital work and that is issued to the first blockchain system comprises:
obtaining the distributed transaction status information that is associated with the digital work and that is issued to the first blockchain system;
invoking a digital contract template to parse the distributed transaction status information, wherein the digital contract template is a smart contract creation program that declares the usage event and that corresponds to the distributed transaction logic; and
creating the smart contract corresponding to the distributed transaction of the digital work.

6. The computer-implemented method of claim 5, further comprising:
issuing a new distributed transaction status information to the first blockchain system, wherein the new distributed transaction status information comprises a distributed transaction proportion of the digital work that is declared in the smart contract.

7. The computer-implemented method of claim 1, further comprising:
deleting the smart contract; and
issuing a new distributed transaction status information to the first blockchain system, wherein a distributed transaction content corresponding to the smart contract is deleted from the new distributed transaction status information.

8. The computer-implemented method of claim 1, wherein the smart contract comprises a unique identifier associated with the digital work.

9. The computer-implemented method of claim 8, wherein the unique identifier is a digest of the digital work.

10. The computer-implemented method of claim 1, wherein the digital work is a music work.

11. A non-transitory, computer-readable medium storing one or more instructions executable by a computer system to perform operations comprising:
receiving a request to process a distributed transaction in a system having a plurality of blockchain systems, each blockchain system maintaining a separate blockchain corresponding respectively to a different entity of a plurality of entities, wherein the distributed transaction is initiated by a member node device in a first blockchain system of the plurality of blockchain systems, and wherein the distributed transaction is associated with a usage event of a digital work, wherein the digital work is associated with multiple levels of the entities; and
invoking a smart contract corresponding to a second blockchain system of the plurality of blockchain systems, comprising:
executing distributed transaction logic for the distributed transaction defined by the smart contract for the second blockchain system; and
computing amounts to be assigned to each entity of the plurality of the entities based on the multiple levels of the entities.

12. The non-transitory, computer-readable medium of claim 11, wherein a distributed transaction proportion corresponding to each entity is declared in the smart contract; and computing the amounts to be assigned to each entity of the plurality of the entities based on the multiple levels of the entities comprises:
computing amounts to be assigned to each entity of the plurality of the entities based on the distributed transaction proportion corresponding to each entity.

13. The non-transitory, computer-readable medium of claim 11, wherein invoking the smart contract corresponding to the second blockchain system of the plurality of blockchain systems comprises:
invoking a first smart contract corresponding to a first-level entity in the multiple levels of the entities, comprising:
executing distributed transaction logic corresponding to the usage event declared in the first smart contract; and
computing amounts to be assigned to the first-level entity;
submitting a distributed transaction result for the first-level entity to a second smart contract corresponding to a second-level entity;
invoking the second smart contract, comprising:
executing distributed transaction logic that is declared in the second smart contract and that corresponds to the usage event; and
computing amounts to be assigned to the second-level entity; and
performing the above process iteratively until the amounts to be assigned to each level of the multiple levels of the entities are computed.

14. The non-transitory, computer-readable medium of claim 11, wherein the smart contract is generated based on a distributed transaction status information that is associated with the digital work and that is issued to the first blockchain system, comprising:
obtaining the distributed transaction status information that is associated with the digital work and that is issued to the first blockchain system; and
invoking a smart contract creation program to create the smart contract corresponding to the distributed transaction of the digital work based on the distributed transaction status information.

15. The non-transitory, computer-readable medium of claim 14, wherein generating the smart contract based on the distributed transaction status information that is associated with the digital work and that is issued to the first blockchain system comprises:
obtaining the distributed transaction status information that is associated with the digital work and that is issued to the first blockchain system;
invoking a digital contract template to parse the distributed transaction status information, wherein the digital contract template is a smart contract creation program that declares the usage event and that corresponds to the distributed transaction logic; and
creating the smart contract corresponding to the distributed transaction of the digital work.

16. The non-transitory, computer-readable medium of claim 15, the operations further comprise:
issuing a new distributed transaction status information to the first blockchain system, wherein the new distributed transaction status information comprises a distributed transaction proportion of the digital work that is declared in the smart contract.

17. The non-transitory, computer-readable medium of claim 11, the operations further comprise:
deleting the smart contract; and
issuing a new distributed transaction status information to the first blockchain system, wherein a distributed transaction content corresponding to the smart contract is deleted from the new distributed transaction status information.

18. The non-transitory, computer-readable medium of claim 11, wherein the smart contract comprises a unique identifier associated with the digital work.

19. The non-transitory, computer-readable medium of claim 18, wherein the unique identifier is a digest of the digital work.

20. The non-transitory, computer-readable medium of claim 11, wherein the digital work is a music work.

21. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations comprising:
receiving a request to process a distributed transaction in a system having a plurality of blockchain systems, each blockchain system maintaining a separate blockchain corresponding respectively to a different entity of a plurality of entities, wherein the distributed transaction is initiated by a member node device in a first blockchain system of the plurality of blockchain systems, and wherein the distributed transaction is associated with a usage event of a digital work, wherein the digital work is associated with multiple levels of the entities; and
invoking a smart contract corresponding to a second blockchain system of the plurality of blockchain systems, comprising:
executing distributed transaction logic for the distributed transaction defined by the smart contract for the second blockchain system; and
computing amounts to be assigned to each entity of the plurality of the entities based on the multiple levels of the entities.

22. The computer-implemented system of claim 21, wherein a distributed transaction proportion corresponding to each entity is declared in the smart contract; and computing the amounts to be assigned to each entity of the plurality of the entities based on the multiple levels of the entities comprises:
computing amounts to be assigned to each entity of the plurality of the entities based on the distributed transaction proportion corresponding to each entity.

23. The computer-implemented system of claim 21, wherein invoking the smart contract corresponding to the second blockchain system of the plurality of blockchain systems comprises:
invoking a first smart contract corresponding to a first-level entity in the multiple levels of the entities, comprising:
executing distributed transaction logic corresponding to the usage event declared in the first smart contract; and
computing amounts to be assigned to the first-level entity;
submitting a distributed transaction result for the first-level entity to a second smart contract corresponding to a second-level entity;
invoking the second smart contract, comprising:
executing distributed transaction logic that is declared in the second smart contract and that corresponds to the usage event; and
computing amounts to be assigned to the second-level entity; and
performing the above process iteratively until the amounts to be assigned to each level of the multiple levels of the entities are computed.

24. The computer-implemented system of claim 21, wherein the smart contract is generated based on a distributed transaction status information that is associated with the digital work and that is issued to the first blockchain system, comprising:
obtaining the distributed transaction status information that is associated with the digital work and that is issued to the first blockchain system; and
invoking a smart contract creation program to create the smart contract corresponding to the distributed transaction of the digital work based on the distributed transaction status information.

25. The computer-implemented system of claim 24, wherein generating the smart contract based on the distributed transaction status information that is associated with the digital work and that is issued to the first blockchain system comprises:
obtaining the distributed transaction status information that is associated with the digital work and that is issued to the first blockchain system;
invoking a digital contract template to parse the distributed transaction status information, wherein the digital contract template is a smart contract creation program that declares the usage event and that corresponds to the distributed transaction logic; and
creating the smart contract corresponding to the distributed transaction of the digital work.

26. The computer-implemented system of claim 25, the operations further comprise:
issuing a new distributed transaction status information to the first blockchain system, wherein the new distributed transaction status information comprises a distributed transaction proportion of the digital work that is declared in the smart contract.

27. The computer-implemented system of claim 21, the operations further comprise:
deleting the smart contract; and
issuing a new distributed transaction status information to the first blockchain system, wherein a distributed transaction content corresponding to the smart contract is deleted from the new distributed transaction status information.

28. The computer-implemented system of claim 21, wherein the smart contract comprises a unique identifier associated with the digital work.

29. The computer-implemented system of claim 28, wherein the unique identifier is a digest of the digital work.

30. The computer-implemented system of claim 21, wherein the digital work is a music work.
